(19) United States
(12) Patent Application Publication
(10) Pub. No.: US 2007/0217379 A1
(43) Pub. Date: Sep. 20, 2007

(54) Terminal location system and positioning method

(75) Inventors: Ryosuke Fujiwara, Kodaira (JP); Masayuki Miyazaki, Tokyo (JP); Kenichi Mizugaki, Kodaira (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 11/651,083

(22) Filed: Jan. 9, 2007

(30) Foreign Application Priority Data
Mar. 17, 2006 (JP) 2006-074616

(51) Int. Cl. H04Q 7/24

(52) U.S. Cl. 370/338

(57) ABSTRACT

A location system of a configuration that facilitates initial introduction, maintenance, and system expansion. A terminal location system basically has at least (N+1) base station (here, N=1 to 3) and a location server and finds a position of a terminal performing wireless communication in N-dimensional coordinates. Further, the terminal location system calculates distances among the at least (N+1) base stations, finds relative coordinates of the base stations, evaluates the obtained relative coordinates, determines switching to terminal location processing of finding the position of the terminal, and finds the position of the terminal using propagation times of radio signals transmitted/received among the terminal and the base stations and the obtained relative coordinates of the base stations.

### CLAIM OF PRIORITY

The present application claims priority from Japanese application JP 2006-074616 filed on Mar. 17, 2006, the content of which is hereby incorporated by reference into this application.

### FIELD OF THE INVENTION

This invention relates to a wireless communication system, and, more specifically, to a terminal location system for positioning a wireless communication terminal and for fixing a position of a base station used for positioning.

### BACKGROUND OF THE INVENTION

To measure a position of a mobile terminal, a system has been proposed that calculates a propagation distance of a signal from a node to each base station and detects a position of the node by calculating differences in the time at which the plurality of base stations receive a signal transmitted from the terminal and multiplying the received time differences of arrival by the velocity of light (for example, see A. Ogino et al., “Wireless LAN integrated access system (1) Study on location system,” Proceeding of the 2005 IEICE General Conference, B-5-203, p.662).

For example, JP-A No. 140617/2005 discloses a terminal location system having a plurality of base stations. This terminal location system has a position calculation server, access points (base stations), a reference station, and a node (terminal). Each base station and the position calculation server are connected with a wired network.

A node is equipped with a wireless transmitting function and a reference station has a receiving function of a radio signal transmitted from the node and a transmitted function of a reference signal. Each access point is equipped with a receiving function of the reference signal and a measuring function for measuring an interval between received signals.

Each access point receives the reference signal transmitted from the reference station, and synchronizes time among access points. Each access point receives the radio signal transmitted from the node, and measures a time difference of arrival as measured from-reception of the reference signal. The position calculation server calculates the position of the node from the measured time differences of arrival (for example, see JP-A No. 140617/2005).

Moreover, in order to achieve synchronization among the base stations, a location system using a reference station has been proposed (for example, see K. Mizugaki et al., “Study on over 3 nW/bps low power UWB wireless system (6): 30-cm high-accuracy location system,” Proceeding of the 2005 IEICE Society Conference, A-5-15, p.139).

Further, the above mentioned system places at least three or more UVN nodes in an area where a military force is deployed, forms a wireless network with these UWB nodes, and grasps relative positions of the nodes. At least two or more reference UWB nodes among the UWB nodes are equipped with GPS receivers, and a reference point network that uses positions of the reference UWB nodes on the earth. The UWB node constituting a wireless network grasps a UWB that is carried on and moved by the ally and grasps a position of the mobile node point in the reference point network. Alternatively, the UWB node constituting the wireless network transmits a signal, receives its reflected wave, and grasps enemy positions in the reference point network. Furthermore, a system (for example see JP-A No. 148025/2005) is proposed that can constitute a command and control system by grasping height information as well as longitude and latitude information of the enemy and the ally such as by using velocity data calculable from their temporal variations together.

Moreover, if a radio transmits a packet to a radio that is a communication partner (a second radio), the second radio transmits a packet after a lapse of time equal to integer times a unit time without fail after detecting the packet. There is proposed a ranging and location system for realizing ranging (for example, see JP-A No. 258009/2004) in which a radio measures a time elapsed after the radio transmits a packet until the radio detects a packet of the second radio using a counter, obtains a time by subtracting a time from packet detection to packet transmission and a processing time of the radio itself from the measurement time, and converts it to a propagation distance between itself and the second radio that is the communication partner.

### SUMMARY OF THE INVENTION

In constructing a location system of a terminal using a plurality of base stations described above, there is a problem that a procedure of disposing the base stations so that the system becomes capable of locating the terminal is complex.

Specifically, in the conventional terminal location system described above, it is necessary that coordinates of the base stations are known beforehand in order to calculate a position of the terminal. However, the conventional terminal location system poses a problem that since the coordinates of the base stations are measured manually, manpower, time, and cost in initially introducing the system and in maintenance are large, which forms a barrier against introduction of the system.

Moreover, the base stations need to be connected with one another in a cable network system, and wiring between the location server and each base station needs to be laid. Because of these constraints, a cost at the time of introduction of the system and a cost at the time of maintenance increase. Moreover, there is also a problem of decrease of flexibility in base station disposition.

Furthermore, when adding a new base station to expand a possible area of the terminal location, there will arise a problem of increase in manpower, time, and costs similarly.

The present invention provides a location system that facilitates initial introduction, maintenance, and expansion of the system itself.

According to a typical form of the present invention, a terminal location system has at least (N+1) base stations (here, N may be, for example, 1 to 3) and a location server, and finds a position of a terminal performing wireless communication in the N-dimensional coordinates. Further, the terminal location system calculates distances among the at least (N+1) base stations, finds relative coordinates of the respective base stations, evaluates the obtained coordinates, determines switching to terminal location processing for finding the position of the terminal, and finds the position of the terminal by using propagation times of radio signals transmitted/received among the terminal and the respective base stations and the obtained relative coordinates of the base stations.

According to the one embodiment of this invention, since it is not necessary to measure disposed positions manually and the relative coordinates of the base stations can be found by wireless communication, introduction of the terminal location system can be simplified.

### BRIEF DESCRIPTION OF THE DRAWINGS

FIG. 1A is a block diagram of a terminal location system of a first embodiment of this invention;

FIG. 1B is a block diagram of a wireless communication apparatus of the first embodiment of this invention;

FIG. 2 is an explanatory diagram of a signal waveform used in UWB-IR communication of the first embodiment of this invention;

FIG. 3 is a detailed block diagram of the UWB wireless communication apparatus of the first embodiment of this invention;

FIG. 4 is a flowchart showing an operation of the whole terminal location system of the first embodiment of this invention;

FIG. 5 is a flowchart showing a detailed procedure of ranging standby mode shift processing of the first embodiment of this invention;

FIG. 6 is a sequence diagram showing a procedure of ranging among base stations of the first embodiment of this invention;

FIG. 7 is a sequence diagram showing the procedure of ranging among the base stations of the first embodiment of this invention;

FIG. 8 is a diagram of a display example of a relative coordinate detection result of the first embodiment of this invention;

FIG. 9 is a sequence diagram showing a switching procedure to a terminal location mode of the first embodiment of this invention;

FIG. 10 is a sequence diagram showing a location procedure of the terminal of the first embodiment of this invention;

FIG. 11 is a block diagram of a terminal location system of a second embodiment of this invention;

FIG. 12 is a block diagram of a terminal location system of a third embodiment of this invention;

FIG. 13 is a sequence diagram showing a procedure of ranging among the base stations of the third embodiment of this invention; and

FIG. 14 is a sequence diagram showing a switching procedure to the terminal location mode of the third embodiment of this invention; and

FIG. 15 is a sequence diagram showing a location procedure of the terminal of the third embodiment of this invention.

### DETAILED DESCRIPTION OF THE PREFERRED EMBODIMENTS

It is to be understood that the figures and descriptions of the present invention have been simplified to illustrate elements that are relevant for a clear understanding of the present invention, while eliminating, for the purpose of clarity, many other elements found in typical wireless communication applications, and systems and methods of using the same. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art. Hereinafter, exemplary embodiments of the present invention will be described with reference to the drawings.

### First Embodiment

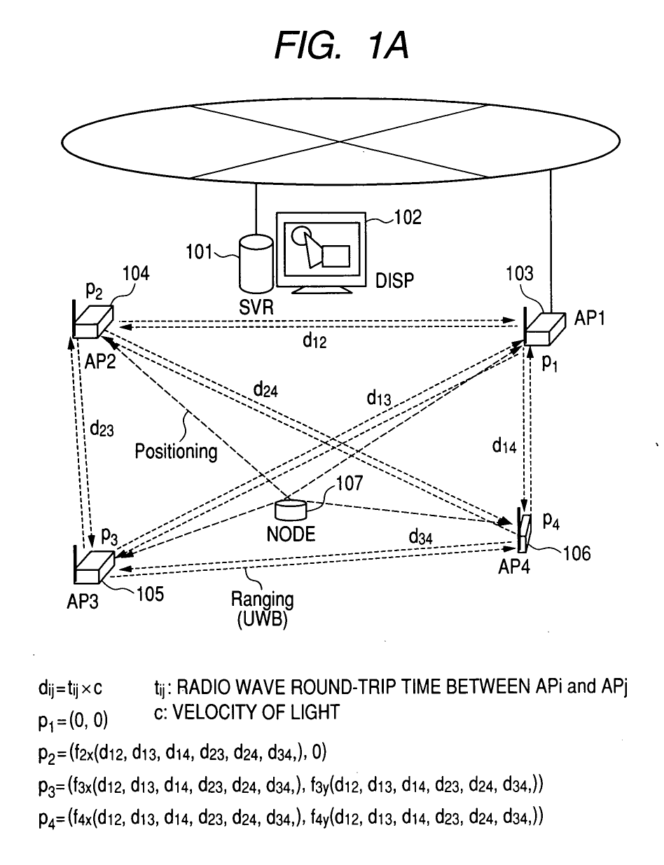

A first embodiment of receiving equipment of this invention will be described using FIGS. 1A to 10.

FIG. 1A is a configuration diagram of a terminal location system of the first embodiment.

The terminal location system of the first embodiment has a location server (SVR) 101, a display (DISP) 102, base stations (AP1 to AP4) 103, 104, 105, and 106, and a terminal (NODE) 107.

The location server 101 is a computer for calculating a position of the terminal 107 connected with the terminal location system of this embodiment, being equipped with a CPU, a storage device, and a communication interface. An input/output device 102 is a user interface connected with the location server 101, including a keyboard, a mouse, and a display unit, for example.

The base stations (AP1 to AP4) 103, 104, 105, and 106 are each equipped with a wireless communication apparatus 115 for measuring transmission/reception timing of a radio signal. At least one base station (in this embodiment, AP1) 103 is connected with the location server 101 with a wire circuit.

The terminal 107 is equipped with wireless transmitting/receiving equipment, and communicates with the base station 103 etc.

In such a terminal location system, in order to measure the position of the terminal 107, it is necessary to fix the positions of the base stations 103-106. For this purpose, in the embodiment of this invention, distances among the base stations 103-106 are measured and relative positions of the base stations are found before measuring the position of the terminal.

In the embodiment of this invention, twice the distance between the base stations (dij) is obtained by measuring a round trip time (tij) of a ranging signal transmitted/received between the base stations and multiplying this round trip time by the velocity of light. Then, a position of a base station that is assigned as a reference of the relative coordinates (in the example, a position of AP1, p1) is set to be in a point of origin and relative coordinates of the other base stations (p2 to p4) are found.

In the case of finding the position of the terminal 107 in N-dimensions, (N+1) base stations with known positions are needed. For example, in the case of finding the position of the terminal 107 in three-dimensional space, four base stations with known positions are needed. In the case of finding a position of the terminal 107 on a fixed straight line (one-dimensional space), two base stations with known positions are needed.

FIG. 1B is a block diagram of the wireless communication apparatus 115 of a first embodiment.

The wireless communication apparatus 115 is a UWB-IR communication apparatus using an Ultra wideband impulse radio.

The UWB-IR communication apparatus 115 has an antenna (ANT) 108, a switch (SW) 109, a UWB receiver (UWB_RX) 110, a UWB transmitter (UWB_TX) 114, a MAC control unit (MAC) 111, a data link control unit (DLC) 112, and a counter (COUNTER) 113.

The antenna 108 catches a radio signal transmitted from the base station, and emits a radio signal to the base station. The switch 109 separates a radio signal transmitted/received by the antenna 108 into a transmission signal and a received signal. In stead of the switch 109, a duplexer or circulator may be used to separate the transmission signal and the received signal as will be apparent to one of skill in the art.

The UWB receiver 110 receives (amplifies, frequency-converts, and demodulates) a radio signal transmitted from the base station, and generates a baseband signal. The UWB transmitter 114 generates (modulates, frequency -converts, and amplifies) an RF signal transmitted to the base station from a baseband signal.

The MAC control unit 111 is made up of software or hardware for controlling transmission/reception timing of a packet and controls a protocol in a MAC layer. The data-link control unit 112 is made up of software or hardware for controlling transmission/reception timing of a packet and controls a protocol in a data link layer.

The counter 113 measures the transmission/reception timing of the radio signal. Specifically, the counter measures a time difference from the time of transmission of the UWB signal by the UWB transmitter 114 to the time of reception of the UWB signal by the UWB receiver 110. This measured time difference is a round trip propagation time of the signal. Moreover, the time difference between the reception time of the first signal by the UWB receiver 110 and the reception time of the second signal thereby is measured. This measured time difference is a time difference of arrival of the signal.

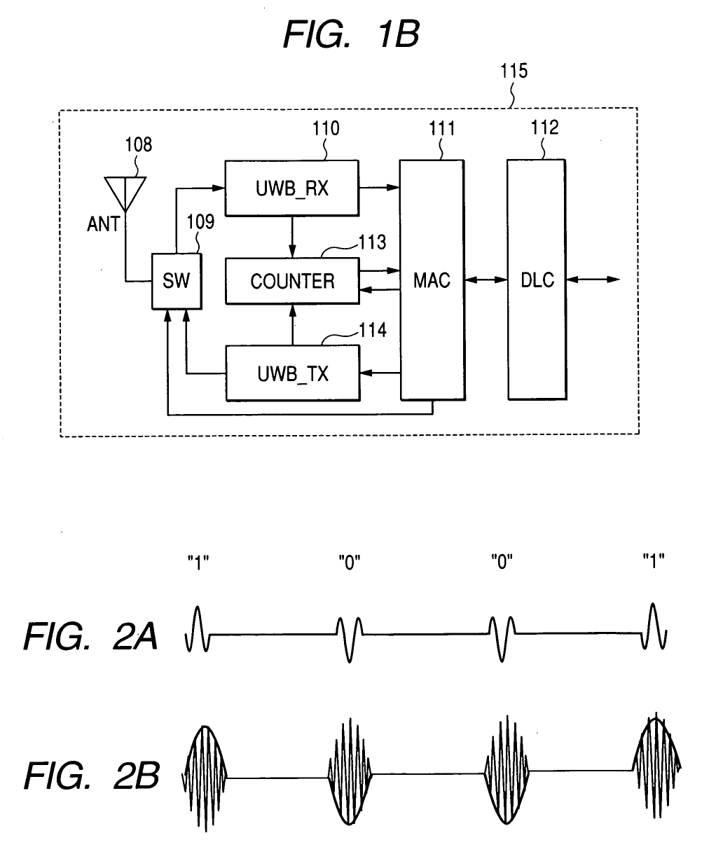

FIG. 2 is a diagram illustrating a signal waveform used in the UWB-IR communication of the first embodiment.

The UWB-IR communication uses a pulse signal of a narrow width. Because of this, the counter 113 can measure a reception time difference accurately.

Demodulation of a radio signal in FIG. 2B yields a pulse signal of a narrow width in FIG. 2A. It is preferable to shorten this pulse width to, for example, 3 ns or less (more preferably, about 2 ns).

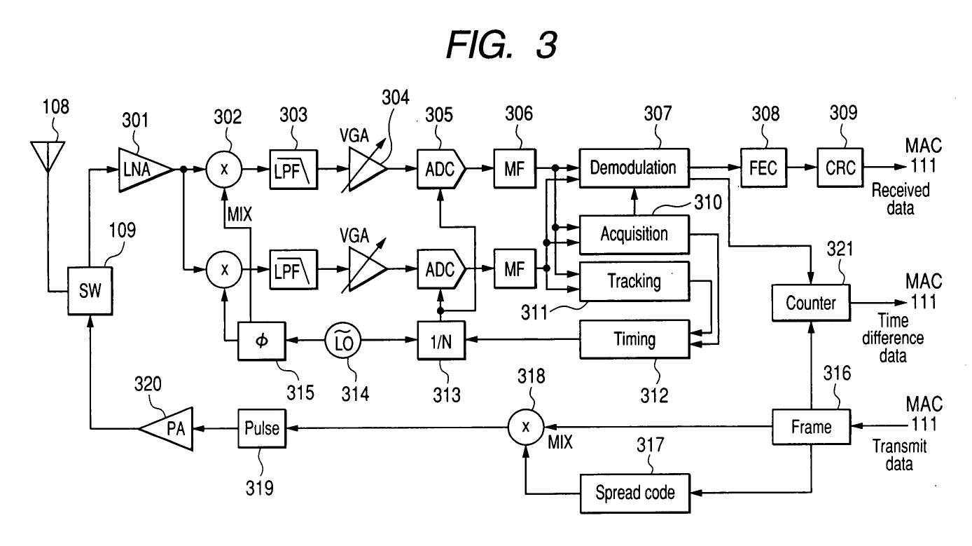

FIG. 3 is a detailed block diagram of a physical layer portion of the UWB wireless communication apparatus 115 of the first embodiment, showing the MAC control unit 111 in FIG. 1A and its left side.

The UWB wireless communication apparatus 115 shown in FIG. 3 has the antenna (ANT) 108, the switch (SW) 109, a low noise amplifier (LNA) 301, a multiplier (MIX) 302, a low pass filter (LPF) 303, a variable amplifier (VGA) 304, an analog-to-digital converter (ADC) 305, and a matched filter (MF) 306, a demodulation unit (Demodulation) 307, an error correction decoder (FEC) 308, a CRC decode unit (CRC) 309, a synchronization acquisition unit (Acquisition) 310, a synchronous tracking unit (Tracking) 311, a timing control unit (Timing) 312, a divider (1/N) 313, a local oscillator (LO) 314, a phase shifter (φ) 315, a frame generator (Frame) 316, a spread code generator (Step Spread code) 317, a multiplier (MIX) 318, a pulse generator (Pulse) 319, a power amplifier (PA) 320, and the counter (Counter) 113.

The low noise amplifier 301 amplifies the received signal separated by the switch 109. The multiplier 302 mixes a local signal generated by the local oscillator 314 and a received signal to convert a frequency of the received signal. The low pass filter 303 selects a signal of a desired intermediate frequency from the signal whose frequency is converted by the multiplier 302. The variable amplifier 304 amplifies the signal selected by the low pass filter 303 to a desired level.

The analog-to-digital converter 305 converts the analog signal amplified by the variable amplifier 304 into a digital signal. The matched filter 306 performs inverse spread spectrum modulation on the digital signal converted by the analog-to-digital converter 305 using a spread code. The demodulation unit 307 demodulates the signal that is subjected to the inverse spread modulation by the matched filter 306. The error correction decoder 308 and the CRC decode unit 309 correct an error produced in a transmission path using an error correcting code that was given to the received signal.

The synchronization acquisition unit 310 extracts a pulse signal contained in the received signal, and extracts timing of the pulse signal. The synchronous tracking unit 311 holds the timing of the received pulse signal, tracks a shift between the pulse signal and the clock signal generated by the timing control unit 312, and directs correction of the shift of the timing to the timing control unit 312. The timing control unit 312 sends to the divider 313 a direction of correcting the timing of the clock signal being supplied to the analog-to-digital converter 305.

The divider 313 divides a local signal generated by the local oscillator 314, and generates a timing signal being supplied to the analog-to-digital converter 305. The local oscillator 314 generates a local signal used for frequency conversion of the received signal. Moreover, the local signal generated by the local oscillator 314 is divided by the divider 313, supplied to the analog-to-digital converter 305, and becomes a clock signal that serves as a reference to operations of the analog-to-digital converter 305.

The frame generator 316 generates a frame from the transmission signal sent from the MAC control unit 111. The spread code generator 317 generates the spread code used for spreading the frame generated by the frame generator 316.

The multiplier 318 mixes the frame generated by the frame generator 316 and the spectrum spread signal generated by the spread code generator 317 to generate a transmission signal.

The pulse generator 319 generates a pulse signal based on the transmission signal whose spectrum is spread by the multiplier 318. The power amplifier 320 amplifies the generated pulse signal to a desired level.

Next, a flow of the signal in the UWB-IR communication apparatus 115 will be explained.

A signal received by the antenna 108 is amplified to a desired level by the low noise amplifier 301 via the switch 109. A signal outputted from the low noise amplifier 301 is frequency-converted by the multiplier 302, the low pass filter 303, and the local oscillator 314, amplified by the variable amplifier 304, and inputted into the analog-to-digital converter 305. In the analog-to-digital converter 305, the received signal that was subjected to frequency conversion is sampled, quantized, and inversely spread using that same spread code as at the time of transmission by the matched filter 306.

The synchronization acquisition unit 310 establishes synchronization of the received pulse signal with an internal clock, and the synchronous tracking unit 311 keeps the established synchronization. The timing control unit 312 adjusts quantization timing in the analog-to-digital converter 305.

The frame generator 316 generates packet data from the transmission data, and adds the error correcting code and a CRC code to form information bits that should be transmitted. The multiplier 318 multiplies the spread code generated by the spread code generator 317 and the formed bits to generate a spread signal. The spectrum spread signal is formed into a pulse signal by the pulse generator 319, amplified to a desired level by the power amplifier 320, and transmitted from the antenna 108 via the switch 109.

The counter 113 measures a time difference from the time of start of signal transmission to a predetermined timing in the received signal. Moreover, a time difference from the predetermined timing in the received signal to the predetermined timing in a received signal that arrives next is measured. This predetermined timing is, for example, a time of appearance of a specific pattern in the received signal, a time of completion of reception of a packet, etc.

Any kind of communication mode may be used for the wireless communication system of this invention. However, the use of the UWB communication described above enables high-accuracy time measurement, and consequently high-accuracy positioning can be expected. This is because the UWB-IR communication uses a pulse signal of a narrow width, as described above.

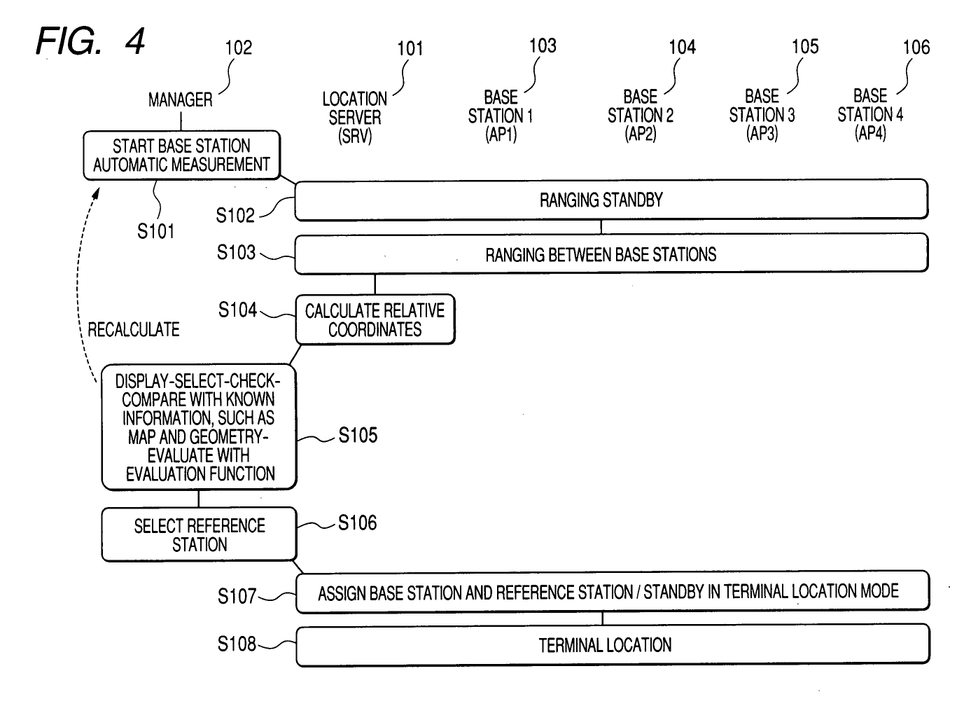

FIG. 4 is a flowchart explaining an operation of the whole terminal location system of the first embodiment.

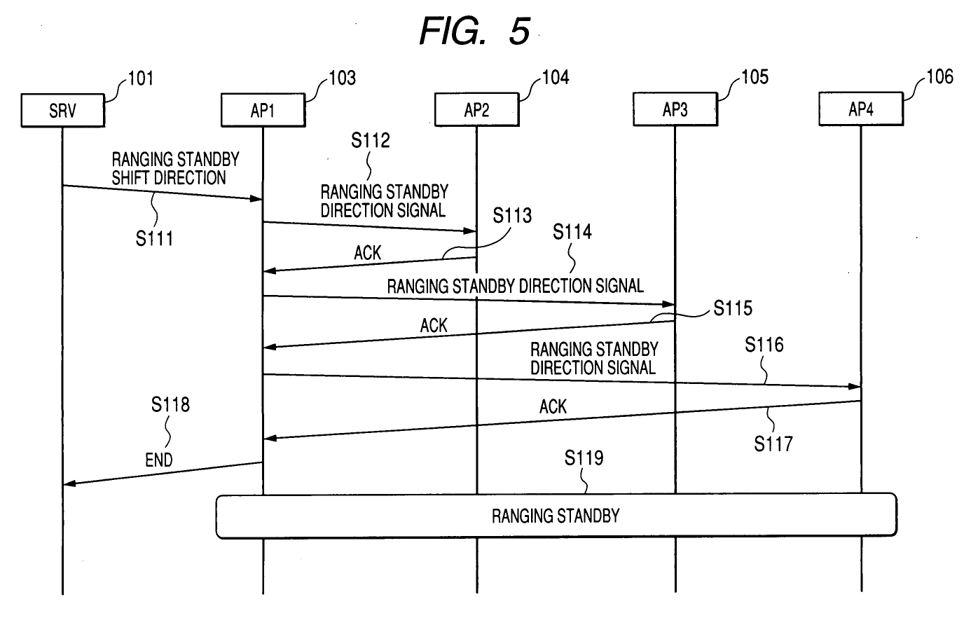

If the location server 101 receives a start command of automatic measurement of distances among the base stations from the input/output device 102 by an operation of the manager (Step S101), the location server 101 and the base stations (AP1 to AP4) 103-106 shift to a ranging standby mode (Step S102). A detailed procedure of the shift to the ranging standby mode will be described later using FIG. 5.

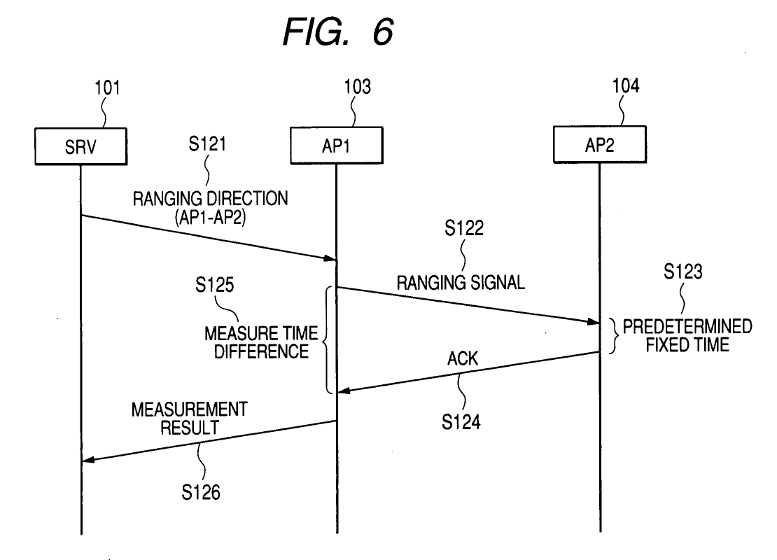

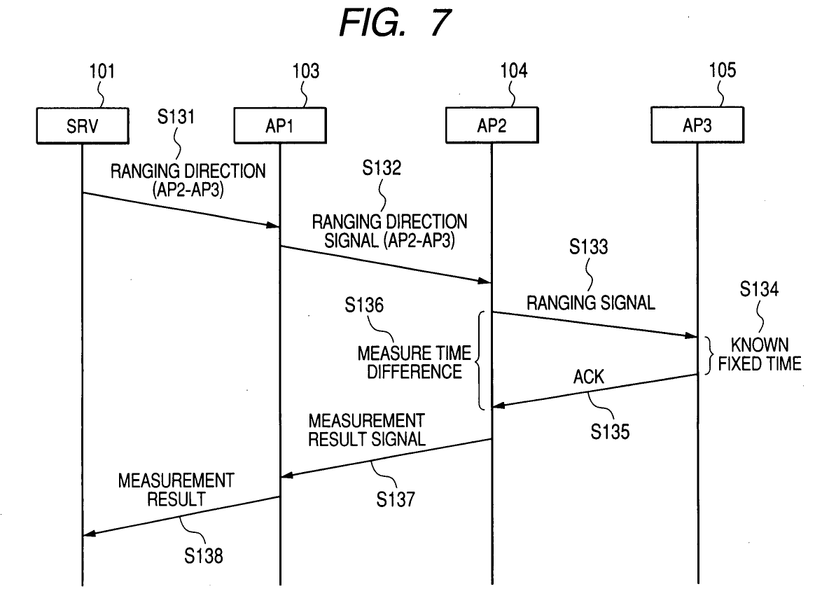

After having shifted to the ranging standby mode, the distances among the base stations (d12, d13, d14, d23, d24, and d34) are measured by multiplying the round trip times between a pair of the base stations by the velocity of light (Step S103). Here, dij denotes a distance between two base stations (AP1 and APj). A detailed ranging procedure will be described later with reference to FIGS. 6 and 7.

After completion of measurement of the distances among the base stations, the location server 101 calculates relative coordinates P1 to P4 of the base stations (AP1 to AP4) 103-106 based on the received ranging results (Step S104). That is, for example, as shown in FIG. 1A, after the coordinates P1 of the base station (AP1) 103 are set to be in a point of origin (0, 0) and the base station (AP2) 104 is set to be a point P2=(d12, 0) on an x-axis, the coordinates of other base stations are calculated.

The cosine formula can be used to calculate the coordinates of other base stations. That is, in the case where distances of three sides of a triangle are known, and two apex points (P1 and P2) among apexes of the triangle are fixed, other coordinates of one point (P3 or P4) can be calculated by the use of the cosine theorem.

However, a relation of mirror image exists, namely positive or negative of coordinates of the remaining one point cannot be obtained.

It is also possible to find coordinates by the least square method using an evaluation function. As an example of the evaluation function, the following formula is conceivable.

$$\begin{matrix}ɛ ( {p}_{2} , {p}_{3} , {p}_{3} , … , {p}_{k} ) = {{a}_{12} ( \vert {p}_{1} - {p}_{2} \vert - {d}_{12} )}^{2} + \\ {{a}_{13} ( \vert {p}_{1} - {p}_{3} \vert - {d}_{13} )}^{2} + … + \\ {{a}_{1 k} ( \vert {p}_{1} - {p}_{k} \vert - {d}_{1 k} )}^{2} + \\ {{a}_{23} ( \vert {p}_{2} - {p}_{3} \vert - {d}_{23} )}^{2} + … + \\ {{a}_{2 k} ( \vert {p}_{2} - {p}_{k} \vert - {d}_{2 k} )}^{2} … + \\ {{a}_{k - 1 k} ( \vert {p}_{k - 1} - {p}_{k} \vert - {d}_{k - 1 k} )}^{2}\end{matrix} \qquad \text{[Formula 1]}$$

This evaluation function gives an error of the coordinates of the base stations. If a value of this evaluation function becomes a minimum, it can be said that the coordinates of the base stations are found with high accuracy.

ε(p₂,p₃,p₃, . . . pₖ)→0 (p₂,p₃,p₃, . . . pₖ) [Formula 2]

Relative coordinates can be found by the formula 2. Here, aij is a weight coefficient and k is the number of the base stations.

Moreover, if there is known information, the accuracy of relative coordinates can be increased by the evaluation function using the known information. For example, if it is known that the base stations (AP1 to AP4) 103-106 are located at apexes of a rectangle, the formula 3 can give the evaluation function by the use of a fact that straight lines each connecting the base stations make an angle of 90°.

ε(p₂,p₃,p₃, . . . pₖ)=ε(p₂,p₃,p₃, . . . pₖ)+φ(p₂, p₃,p₃, . . . ,pₖ) φ(p₂,p₃,p₃, . . . ,pₖ)=b{|(p₂−p₁)|+|(p₄−p₁)|+|(p₂−p₃)·(p₄−p₃)|} [Formula 3]

As described above, obtained calculation results of the relative positions of the base stations are displayed on the input/output device 102.

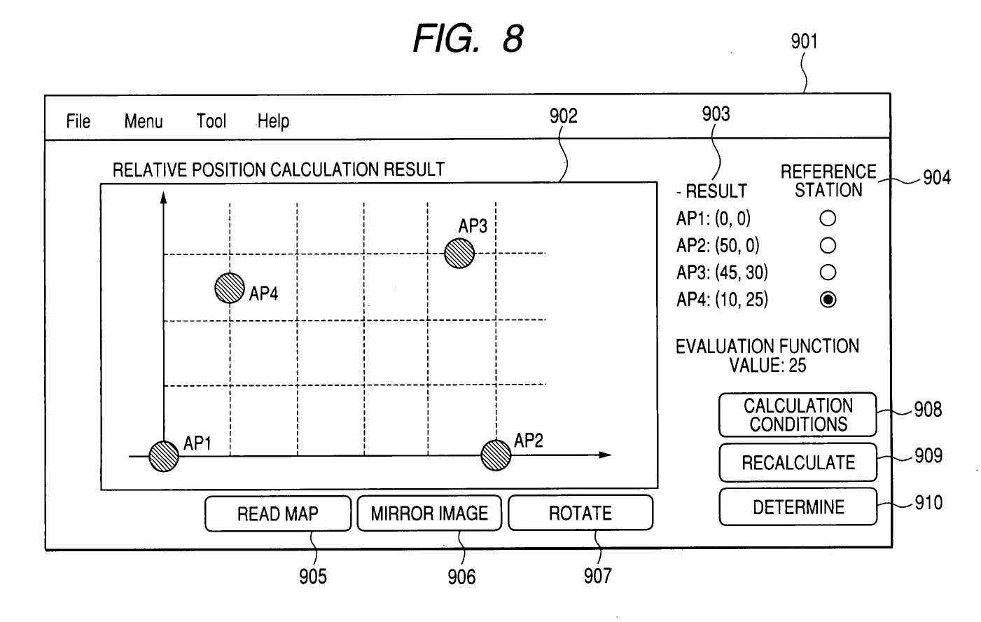

After this, the location server 101 determines whether the calculation results of the relative positions are reasonable (Step S105). Then if it is determined that the calculation results are not reasonable, the relative positions are calculated again. For example, a value of the above-mentioned evaluation function and a predetermined threshold are compared to determine whether re-calculation is necessary. It can be checked whether this determination of the necessity of re-calculation is appropriate by a display screen of the calculation results shown in FIG. 8.

That is, if the value of the evaluation function exceeds the predetermined threshold, it is determined that the accuracy of the coordinates of the base stations need to be further improved by re-calculation. On the other hand, if the value of the evaluation function is equal to or less than the predetermined threshold, indicating that the calculation results are reasonable, it is determined that the obtained values of the coordinates of the base stations have sufficient accuracy, and the location server 101 ends the among-base-station ranging mode and shifts to a terminal location mode.

Since an error of the relative position of the base station propagates to be an error of the position of the terminal to be measured after this, the error of the relative position of the base stations must be kept in a fixed limit. Then, it becomes necessary to define an error of the relative position of the base station depending on a required location error of the terminal.

The determination explained above can also be done by the manager's intention. At this time, a calculation result as shown in FIG. 8 is displayed on the input/output device 102. The manager determines whether the calculation results are reasonable by seeing the calculation results of the displayed relative positions. If the manager determines that the calculation results are reasonable, the manager can make the location server 101 shift to the terminal location mode by operating a determination button 910.

On the other hand, if the manager determines that the calculation results are unreasonable, the manager can make the location server 101 re-calculate the relative positions by operating a re-calculation button 909. For example, based on the value of the evaluation function displayed on the screen, the manager can determine the necessity of re-calculation.

Moreover, when performing the re-calculation, the manager can alter settings, such as alteration of the evaluation function, by operating a calculation condition alteration button 908.

If the relative coordinates are calculated using the distances of the base stations, uncertainty of the relation of mirror image exists, and accordingly the manager selects a relation of mirror image by operating a mirror image button 906.

On the other hand, if the calculation results are determined reasonable, the location server 101 selects at least one from among the base stations (AP1 to AP4) whose relative positions were calculated as a reference station. The reference station may be selected by any kind of criterion. One method is the following method.

As an example of a method for selecting the reference station, a station whose distances to the other base stations have a minimum difference among them may be selected. That is, with max(x, y, z) and min(x, y, z) defined as a maximum and a minimum of x, y, and z, respectively, a base station that minimizes values calculated by the following expressions is selected (Step S106).

AP1: max(d12, d13, d14)—min(d12, d13, d14)

AP2: max(d12, d23, d24)—min(d12, d23, d24)

AP3: max(d13, d23, d34)—min(d13, d23, d34)

AP4: max(d14, d24, d34)—min(d14, d24, d34)

### If the reference station is selected as described above, further if the reference station is disposed in a center of the base stations more accurately, improvement in location accuracy of the terminal can be expected.

In addition, the reference station may also be selected by any method besides this method. Alternatively, the manager may select the base station that is expected to be the reference station from the calculated relative positions.

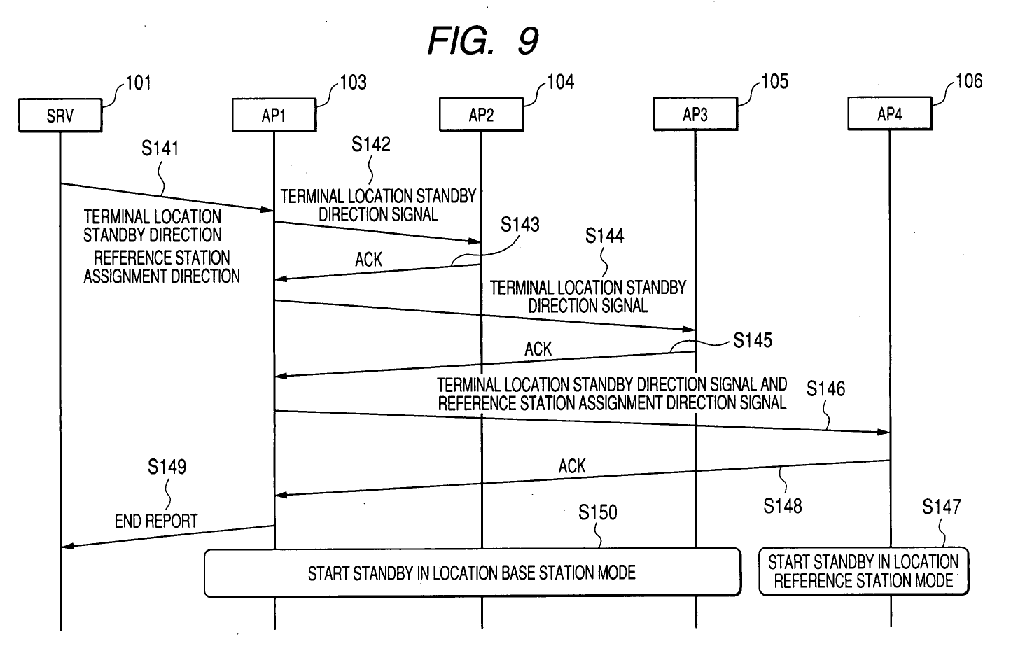

After the selection of the reference station, the location server 101 and the base stations (AP1 to AP4) 103-106 are set to be in a terminal location standby mode (Step S107). However, the base station (AP-4) 104 that is assigned as the reference station is in a standby mode as the reference station. A detailed procedure of switching to the terminal location mode will be described later using FIG. 9.

After that, the base stations (AP1 to AP4) 103-106 each measure a time difference of arrival of a location signal and a reference signal. The location server 101 measures the position of the terminal based on the measurement result of the time differences of arrival (Step S108). Then, the base stations (AP1 to AP4) 103-106 each are set to be in a terminal location standby mode, and wait the location signal.

FIG. 5 is a flowchart showing a detailed procedure of ranging standby mode shift processing of the first embodiment.

First, the location server 101 transmits a ranging standby shift direction to the base station (AP1) 103 connected by wire (Step S111). If the base station (AP1) 103 receives the ranging standby shift direction from the location server 101, the base station (AP1) 103 transmits a ranging standby direction signal to the base station (AP2) 104, the base station (AP3) 105, and the base station (AP4) 106 by wireless communication (Steps S112, S114, S116).

If the base station (AP2) 104, the base station (AP3) 105, and the base station (AP4) 106 each receive the ranging standby direction signal transmitted from the base station (AP1) 103, each of them shifts to a ranging standby state in which the ranging signal that will be transmitted next is waited. At this time, the base station (AP2) 104, the base station (AP3) 105, and the base station (AP4) 106 each transmit an ACK signal (Steps S113, S115, S117).

Although, in FIG. 5, the base station (AP1) 103 transmits the ranging standby direction signal to one base station and, after the reception of the ACK signal, transmits the ranging standby direction signal to the other base stations, the base station (AP1) 103 may transmits the ranging standby direction signal without waiting arrival of the ACK signal.

If the base station (AP1) 103 receives ACK signals from all the base stations to which the ranging standby direction signals were transmitted, the base station (AP1) 103 notifies the location server of completion of processing of shifting to the ranging standby state (Step S118), and shifts to the ranging standby state.

Although this embodiment explained the example where the ACK signal was used, the ACK signal is not necessarily required in the processing of shifting to a standby state in ranging mode.

FIG. 6 is a sequence diagram showing a procedure of ranging between the base station (AP1) 103 and the base station (AP2) 104 of the first embodiment.

First, the location server 101 transmits the ranging direction as to between AP1 and AP2 to the base station (AP1) 103 (Step S121). If the base station (AP1) 103 receives the ranging direction between AP1 and AP2 from the location server 101, the base station (AP1) 103 transmits the ranging signal to the base station (AP2) 104 (Step S122). The base station (AP1) 103 starts operation of the counter 113 at a transmission timing of the ranging signal and starts to measure a round trip propagation time.

If the base station (AP2) 104 receives the ranging signal transmitted from the base station (AP1) 103, the base station (AP2) 104 transmits an ACK signal (Step S124) after a lapse of a previously specified time (Step S123). This previously specified time may be either the same time or a different time for each base station as long as the location server knows the time.

If the base station (AP1) 103 receives the ACK signal transmitted from the base station (AP2) 104, the base station (AP1) 103 stops operation of the counter 113 that started operation on transmission of the ranging signal and measures a time difference between the transmission time of the ranging signal and the reception time of the ACK signal (Step S125). The base station (AP1) 103 transmits a measurement result of the time difference to the location server 101 (Step S126).

For example, with the measurement time for the time difference denoted as T1 and the previously specified time in the base station (AP2) 104 therefor denoted as T2, a distance d12 can be found by the following formula:

d12=(T1−T2)×C,

where C is the velocity of light.

FIG. 7 is a sequence diagram showing a procedure of ranging between the base station (AP2) 104 and the base station (AP3) 105 of the first embodiment.

First, the location server 101 transmits a ranging direction as to between AP2 and AP3 to the base station (AP1) 103 (Step S131). If the base station (AP1) 103 receives the ranging direction as to between AP2 and AP3 from the location server 101, the base station (AP1) 103 transmits a ranging direction signal (between AP2 and AP3) to the base station (AP2) 104 (Step S132).

If the base station (AP2) 104 receives the ranging direction signal (between AP2 and AP3) from the base station (AP1) 103, the base station (AP2) 104 transmits a ranging signal to the base station (AP3) 105 (Step S133). If the base station (AP3) 105 receives the ranging signal transmitted from the base station (AP2), the base station (AP3) 105 transmits an ACK signal (Step S135) after a lapse of the previously specified time (Step S134).

The base station (AP2) 104 measures a difference between a transmission time of the ranging signal and a reception time of the ACK signal (Step S136). The base station (AP2) 104 transmits the measurement result of the time difference to the base station (AP1). If the base station (AP1) 103 receives the measurement result of the time difference from the base station (AP2) 104, the base station (AP1) 103 transmits the received measurement result to the location server 101.

The distances among other base stations are also found by the same procedure as the procedure shown in FIGS. 6 and 7.

FIG. 8 shows an example of a plot of a relative coordinate calculation result of the first embodiment.

A display window 901 that displays the calculation result of the relative positions of the base stations includes a result display as an image 902, a result display as numeric values 903, a reference station selection button 904, a map read button 905, the mirror image button 906, a rotation button 907, the calculation condition alteration button 908, a re-calculation button 909, and the determination button 910.

In the result display 902, calculated relative positions of the base stations are displayed as an image on proper coordinate axes. In the result display 903, calculated relative positions of the base stations are displayed as numeric values using a xy-coordinates. The reference station selection button 904 is used in selecting a base station specified as the reference station.

The map read button 905 is operated when a map of the area including the base stations whose relative positions are calculated is displayed being superimposed on the calculated relative coordinates of the base stations.

The mirror image button 906 is operated when the calculated relative coordinates of the base stations are intended to be reversed about the horizontal axis (axis on which AP1 and AP2 are located) as a reversal axis. In addition, the display window 904 may be so configured that the reversal axis is freely set. The rotation button 907 is operated when rotating the displayed map or the displayed relative positions.

The calculation condition alteration button 908 is operated when altering calculation conditions, such as the evaluation function. The re-calculation button 909 is operated when re-calculating the calculated relative positions of the base stations. The determination button 910 is operated when shifting a mode to the terminal location mode.

FIG. 9 is a sequence diagram showing a switching procedure to the terminal location mode of the first embodiment.

This switching to the terminal location mode is to switch to the terminal location mode after the relative coordinates of the base stations are evaluated (Step S105 of FIG. 4) and the reference station is selected (Step S106 of FIG. 4).

First, the location server 101 transmits a terminal location standby direction and a reference station assignment direction to the base station (AP1) 103 (Step S141). If the base station (AP1) 103 receives the terminal location standby direction and the reference station assignment direction from the location server 101, the base station (AP1) 103 specifies a base station that serves as the reference station. Then, the base station (AP1) 103 transmits a terminal location standby direction signal to the base station (AP2) 104 and the base station (AP3) 105 that do not serve as the reference station (Steps S142, S144). The base station (AP2) 104 and the base station (AP3) 105 that do not serve as the reference station each shift to a standby state in location base station mode in which each of them waits the location signal transmitted from the terminal (Step S150) and sends back an ACK signal to the base station (AP1) (Steps S143, S145).

Moreover, the base station (AP1) 103 transmits the terminal location standby direction signal and a reference station assignment signal to the base station (AP4) 106 that serves as the reference station (Step S146). The base station (AP-4) 106 that serves as the reference station shifts to a standby state in location reference station mode in which it waits the location signal transmitted from the terminal as the reference station (Step S147), and sends back an ACK signal to the base station (AP1) 103 (Step S148).

Although in FIG. 9, the base station (AP1) 103 transmits the terminal location standby direction signal to one base station and, when receiving the ACK signal, transmits the terminal location standby direction signal to the other base stations, the base station (AP1) 103 may transmit the terminal location standby direction signal to the other base stations without waiting arrival of the ACK signal.

If the base station (AP1) 103 receives ACK signals from all the base stations to which the location standby direction signal were transmitted, the base station (AP1) 103 notifies the location server 101 of completion of shift processing of a standby state in terminal location mode (Step S149), and shifts to the standby state in location base station mode (Step S105).

Although in this embodiment, the example of using the ACK signal was explained, the ACK signal is not necessarily required in order that the base station (AP1) 103 shifts to the standby state in terminal location mode.

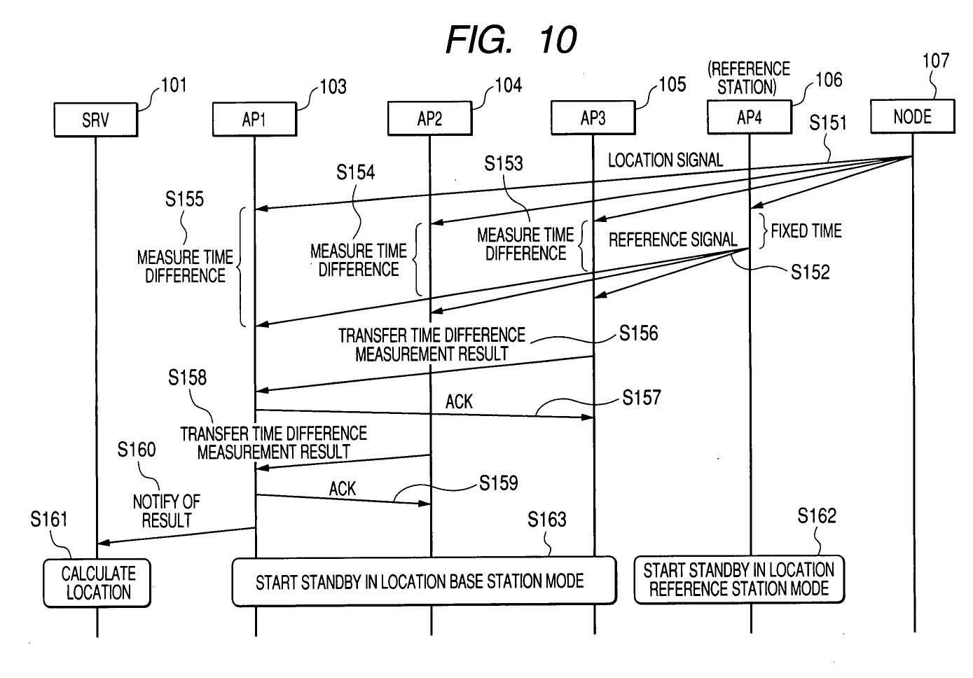

FIG. 10 is a sequence diagram showing a procedure of measuring a position of the terminal of the first embodiment.

First, the terminal 107 transmits the location signal to the neighboring base stations (Step S151). If the base station (AP4) 106 serving as the reference station receives the location signal transmitted from the terminal 107, the base station (AP4) 106 transmits the reference signal to the neighboring base stations after a lapse of the previously specified time (Step S152).

On the other hand, if the base station (AP1) 103, the base station (AP2) 104, and the base station (AP3) 105 that do not serve as the reference station each receive the location signal transmitted from the terminal 107, each of them starts operation of the counter 113 and starts to measure a time difference of arrival. Then, if the base station (AP1) 103, the base station (AP2) 104, and the base station (AP3) 105 each receive the reference signal transmitted from the reference station (AP4) 106, each of them stops operation of the counter 113 that started operation on reception of the location signal and measures a time difference of arrival between the location signal and the reference signal (Steps S153, S154, and S155).

The base station (AP2) 104 and the base station (AP3) 105 each notify the base station (AP1) 103 of a measurement result of the time difference of arrival (Steps S156, S158). If the base station (AP1) 103 receives measurement results from the base station (AP2) 104 and the base station (AP3) 105, the base station (AP1) 103 sends back ACK signals to the base stations that are sender stations of the measurement results, respectively (Steps S157, S159).

After that, the base station (AP1) 103 notifies the location server 101 of all the measurement results received from the other base stations and the measurement result of a time difference of arrival measured by the local station (Step S160). The location server 101 calculates the position of the terminal based on the measurement results of time differences of arrival by the base stations (AP1 to AP3) 103-105, and the calculation result of the relative coordinates of the base stations (AP1 to AP3) 103-105 (Step S161).

After that, the base stations (AP1 to AP3) 103-105 are again set in the standby state in location base station mode. The base station (AP4) 106 that serves as the reference station is again set in the standby state in location reference station mode.

Here, a locating method using time differences of arrival will be explained.

The position of the terminal is found based on the time difference of arrival between the signal from the terminal and the signal from the reference station. That is, each base station finds a difference (T1-T2) between the reception time of the signal from the terminal and the reception time of the signal from the reference station. This difference between the reception times of the signals is equal to a difference (L1-L2) between a distance (L1) from the receiving station to the terminal and a distance (L2) from the receiving station to the reference station divided by a propagation time of the signal (velocity of light).

That is, the receiving station exists on a hyperbola on which a difference between the distance from the receiving station to the terminal and the distance from the receiving station to the reference station is constant (L1-L2). This hyperbola turns to be a curve whose foci are the position of the terminal and the position of the reference station.

Moreover, each of other two base stations also receives a signal from the terminal and a signal from the reference station, finds a time difference of arrival between the two signals, and calculates a hyperbola. This calculation indicates that the position in which the terminal exists is foci of these three hyperbolas.

Thus, if the position of the terminal is measured based on the time differences of arrival of the signals received by the plurality of base stations, even if an error of time common to the measured propagation delay times (T1, T2) is included, this embodiment has a merit of being capable of eliminating it. This is unlike the method of measuring the position of the terminal based on a distance obtained by multiplying the propagation time of a signal from the terminal by the velocity of light.

Although the system for measuring the position of the terminal by measuring a time difference of arrival between the location signal from the terminal and the reference signal from the reference station was explained, the goal of the invention is to find the position of the base station in the system for locating the terminal using the plurality of base stations. Therefore, it is evident that this invention is applicable to a locating method even if it is not the locating method using the time difference of arrival.

As described above, in the first embodiment, the propagation time is used to measure distances among the base stations, and the differences in propagation time of the signal is used to measure the position of the terminal. The reason of using the time and the difference is as follows. Although positioning using the difference in propagation time of a signal is an excellent method whereby a common error can be eliminated as described above, base stations with known positions are necessary. For this reason, the positing method using the difference of propagation time cannot be used at the time of constructing the location system because the positions of the base stations are unknown. However, since quick measurement is not necessary at the time of construction of the location system, accuracy of the distances among the base stations can be improved by performing repeated measurements. Therefore, the location system like this embodiment is most suitable that uses the propagation time of a signal in measuring the distances among the base stations and uses the time differences of arrival of the signals in measuring the position of the terminal.

According to the first embodiment, in constructing a terminal location system, a plurality of base stations are allowed to be disposed without accurately measuring the positions of the disposed base stations, and the relative coordinates of the base stations can be found by wireless communication. Therefore, the manual work at the time of the base station disposition can be eliminated, and initial introduction of the terminal location system can be simplified.

Moreover, since the base stations each transmit/receive a signal to/from the other base stations by wireless communication, laying of wire communication lines can be omitted, so that flexibility in disposing the base stations can be increased.

As explained above, according to the first embodiment, since only a plurality of base stations need to be disposed in constructing the terminal location system, the necessity of measuring positions of the base stations manually is eliminated, and the relative coordinates of the base stations can be found by wireless communication; therefore, introduction of the terminal location system can be simplified.

Since the base stations communicate with one another by radio, wiring does not need to be laid and the flexibility in disposing the base stations can be improved.

In addition, even when adding a base station newly, the relative coordinates of that base station can be found by wireless communication, which can omit manual work and simplify expansion of the terminal location system.

### Second Embodiment

Next, a second embodiment of this invention will be described.

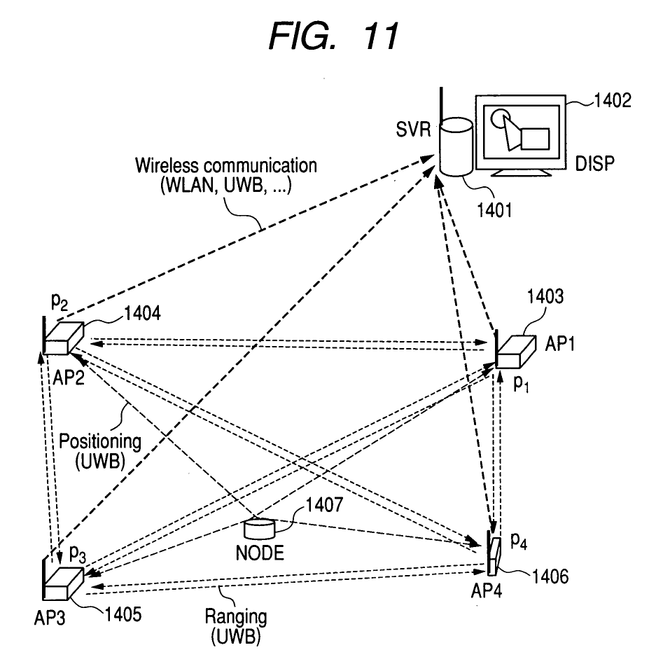

FIG. 11 is a block diagram of a terminal location system of the second embodiment of this invention.

In contrast to the first embodiment where the location server 101 is connected with the base station (AP1) 103 by wire, in the second embodiment that will be explained below, base stations (AP1 to AP4) 1403-1406 are connected with a location server 1401 by radio. That is, instead of wire communication between the location server 101 and the base station (AP1) 103 explained in the first embodiment, the base stations (AP1 to AP4) 1403-1406 each perform wireless communication directly with the location server 1401 in the second embodiment.

Although the location system is so configured that a high-order wireless communication system among these base stations (AP1 to AP4) 1403-1406 and the location server 1401 is wireless LAN and a low-order wireless communication system among the base stations (AP1 to AP4) 1403-1406 is UWB, thereby both systems being specified as different ones, the same system may be used.

The terminal location system of the second embodiment has the location server (SVR) 1401, a display (DISP) 1402, the base stations (AP1 to AP4) 1403, 1404, 1405, and 1406, and a terminal (NODE) 1407.

The location server 1401 of the second embodiment has the identical configuration with that of the location server 101 of the first embodiment. Moreover, the location server 1401 of the second embodiment is equipped with a wireless transmission/reception unit for communicating with the base stations (AP1 to AP4) 1403-1406 by radio.

The base stations (AP1 to AP4) 103-106 of the second embodiment each have the identical configuration with that of the base stations (AP1 to AP4) 103-106 of the first embodiment. Moreover, the base stations (AP1 to AP4) 1403-1406 of the second embodiment are each equipped with the wireless transmission/reception unit for communicating with the location server 1401 by radio.

The wireless transmission/reception unit with which the above-mentioned location server 1401 and the base stations (AP1 to AP4) 1403-1406 are equipped may use the identical wireless communication system to that of the wireless communication system used for ranging and/or location, or may use other wireless communication system. For example, a wireless LAN can be considered as another wireless communication system.

Moreover, the display 1402 and the terminal 1407 of the second embodiment have the identical configurations to those of the location server 101, the display 102, and the terminal 107 of the first embodiment, respectively.

Next, a procedure of operations between the base stations in the second embodiment of this invention will be explained.

In the first embodiment described above, all the signals from the location server 1401 are transmitted via the base station (AP1) 1403. However, in the second embodiment, signals from the location server 1401 are directly transmitted to all the base stations (AP1 to AP4) 1403-1406. Except for this respect, the processing of the second embodiment is the same as that of the first embodiment (see FIG. 5, FIG. 7, FIG. 9, and FIG. 10).

As explained in the foregoing, according to the second embodiment, the need for connection by wire is eliminated for any of the base stations, and accordingly wiring to the base stations can be made unnecessary. Therefore, it is possible to simplify disposition and introduction of a base station and increase the flexibility in disposing the base station.

### Third Embodiment

Next, a third embodiment of this invention will be described.

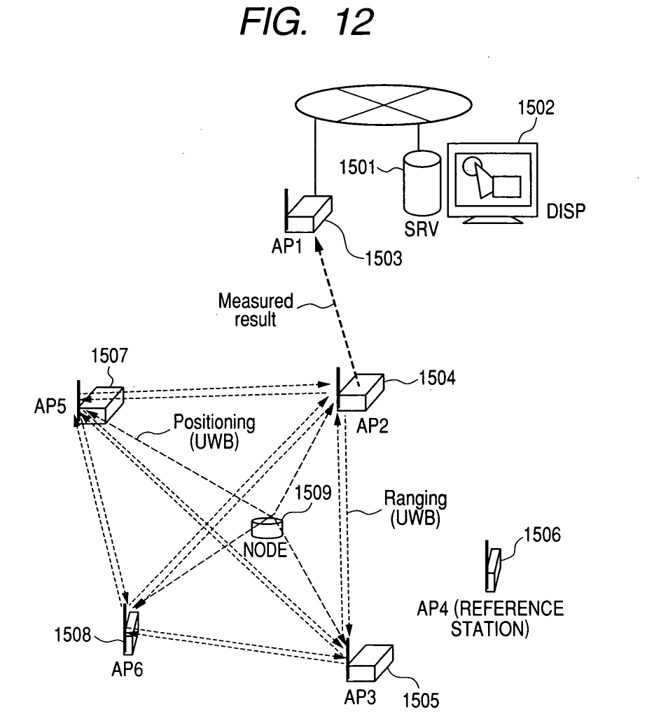

FIG. 12 is a block diagram of a terminal location system of the third embodiment according to this invention.

A terminal location system of the third embodiment has a location server (SVR) 1501, a display (DISP) 1502, base stations (AP1 to AP6) 1503, 1504, 1505, 1506, 1507, and 1508, and a terminal (NODE) 1509. In the third embodiment, the same terminal location system as that of the first embodiment is constructed with the base station (AP2) 1504, the base station (AP3) 1505, the base station (AP5) 1507, and the base station (AP6) 1508. That is, since the base stations are disposed in a range exceeding a communication range of the base station, the range where positioning of the terminal is possible is expanded over the range of the first embodiment.

The base stations (AP1 to AP6) 1503-1508 of the third embodiment each have the same configuration as that of the base stations (AP1 to AP4). Moreover, the base station (AP2) 1504 and the base station (AP3) 1505 are each equipped with a wireless transmission/reception unit by which communication with the base station (AP1) 1503 is performed by radio. Furthermore, the base station (AP2) 1504 and the base station (AP3) 1505 each are equipped with a wireless transmission/reception function by which communication with the base station (AP5) 1507 and the base station (AP5) 1507 is performed by radio. By this, the base station (AP2) 1504 and the base station (AP3) 1505 can relay signals transmitted from the base station (AP5) 1507 and the base station (AP6) 1508 to the base station (AP1) 1503, respectively.

A high-order wireless communication system among this base station (AP1) 1503 and both the base station (AP2) 1504 and the base station (AP3) 1505 is specified as UWB and a low-order wireless communication system among the base stations (AP2 to AP6) 1504-1508 is specified as UWB, so the both systems being the same. However, the two systems may use different ratio communication systems. For example, a possible configuration is that the high-order wireless communication system is specified as a wireless LAN and the low-order wireless communication system is specified as UWB.

The location server 1501 of the third embodiment, the display 1502, and the terminal 1509 have the identical configurations to those of the location server 101, the display 102, the terminal 107 of the first embodiment, respectively.

Operations of the terminal location system constructed with the base station (AP2) 1504, the base station (AP3) 1505, the base station (AP5) 1507, and the base station (AP6) 1508 can be explained as one such that the location server 101 of the first embodiment (FIG. 4) is replaced with the location server 1501, the base stations (AP1 to AP4) 103-106 are replaced with the base stations (AP1 to AP6) 1503-1508, and the terminal 107 is replaced with the terminal 1509. Specifically, the terminal location system is as described below.

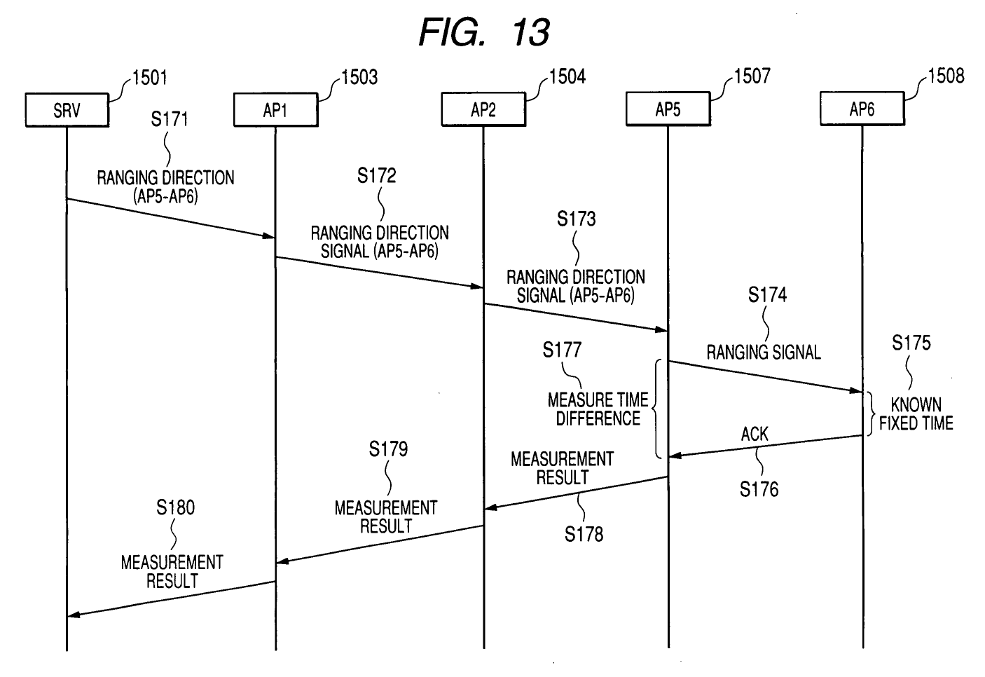

FIG. 13 is a sequence diagram showing a procedure of ranging between the base station (AP5) 1507 and the base station (AP6) 1508 of the third embodiment.

First, the location server 1501 transmits a ranging direction signal as to between AP5 and AP6 to the base station (AP1) 1503 (Step S171). The location server 1501 keeps routing information indicating transfer paths of signals to the base stations, and the routing information is transmitted along with the ranging direction signal.

If the base station (AP1) 1503 receives a ranging direction as to between AP5 and AP6 from the location server 1501, the base station (AP1) 1503 refers to the routing information transmitted from the location server 1501, specifies the base station (AP2) 1504 that serves as a path to the base station (AP5) 1507, and transmits a ranging direction signal (between AP5 and AP6) to the specified base station (AP2) 1504 (Step S172). If the base station (AP2) 1504 receives the ranging direction signal transmitted from the base station (AP1) 1503, the base station (AP2) 1504 transmits a ranging direction signal (between AP5 and AP6) to the base station (AP5) 1507 (Step S173).

If the base station (AP5) 1507 receives the ranging direction signal transferred from the base station (AP2) 1504, the base station (APS) 1507 transmits a ranging signal to the base station (AP6) 1508 (Step S174). The base station (AP5) 1507 starts operation of the counter 113 at a transmission timing of the ranging signal and starts to measure the round-trip propagation time.

If the base station (AP6) 1508 receives the ranging signal transmitted from the base station (AP5) 1507, the base station (AP6) 1508 transmits an ACK signal (Step S176) after a lapse of the previously specified time (Step S175).

If the base station (AP5) 1507 receives the ACK signal transmitted from the base station (AP6) 1508, the base station (AP5) 1507 stops operation of the counter 113 that started operation on transmission of the ranging signal and measures a difference between the transmission time of the ranging signal and the reception time of the ACK signal (Step S177). The received measurement result is transmitted to the location server 1501 in a route reverse to the ranging direction signal via the base station (AP2) 1504 and the base station (AP1) 1503.

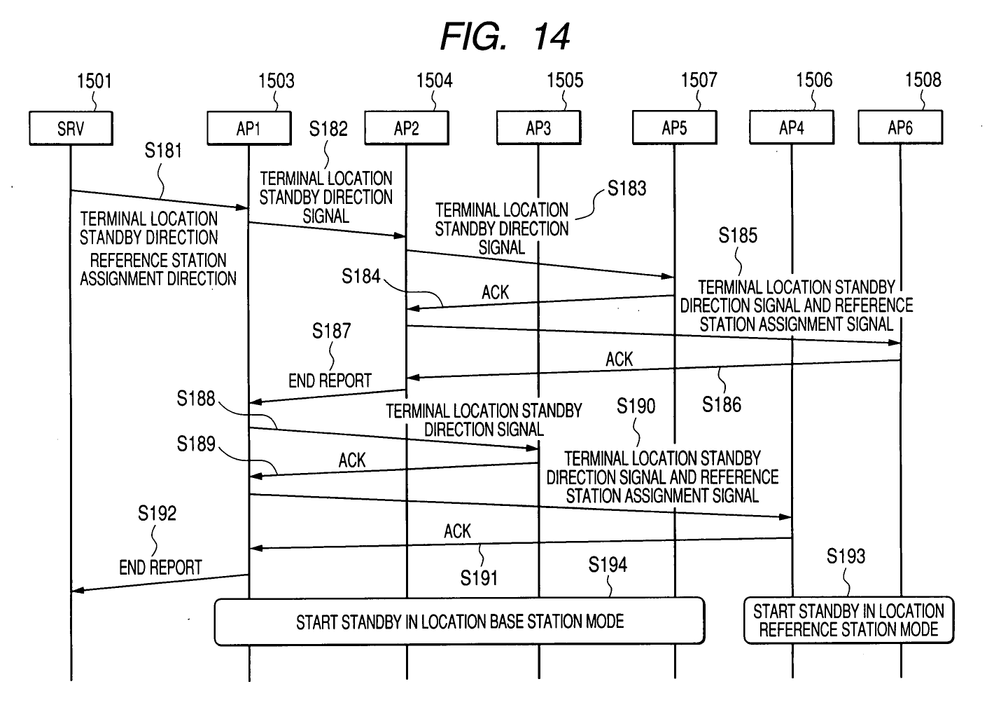

FIG. 14 is a sequence diagram showing a switching procedure to the terminal location mode of the third embodiment.

In the example shown in FIG. 14, the base station (AP4) 1506 and the base station (AP6) 1508 are selected as the reference stations.

First, the location server 1501 transmits a terminal location standby direction and a reference station assignment direction to the base station (AP1) 1503 (Step S181). If the base station (AP1) 1503 receives the terminal location standby direction and the reference station assignment direction from the location server 101, the base station (AP1) 1503 refers to routing information transmitted along with the terminal location standby direction, and specifies the base station (APS) 1507 that is a destination and the base station (AP2) 1504 that serves as a path to the base station (AP6) 1508. Then, the base station (AP1) 1503 transmits the terminal location standby direction and the reference station assignment direction to the specified base station (AP2) 1504 (Step S182).

If the base station (AP2) 1504 receives a terminal location standby direction signal transmitted from the base station (AP1) 1503, the base station (AP2) 1504 extracts reference station assignment information contained in the terminal location standby direction signal and specifies the base station that serves as the reference station. The base station (AP2) 1504 transmits a terminal location standby direction signal to the base station (AP5) 1507 that does not serve as the reference station (Step S183), and transmits a terminal location standby direction signal and a reference station assignment signal to the base station (AP6) 1508 that serves as the reference station (Step S185).

If the base station (AP5) 1507 and the base station (AP6) 1508 each receive the terminal location standby direction signal from the base station (AP2) 1504, each of them sends back an ACK signal (Steps S184, S186) and shifts to a terminal location standby state (Steps S193, S194).

Moreover, the base station (AP1) 1503 transmits the terminal location standby direction signal to the base station (AP3) 1505 that does not serve as the reference station (Step S186), and transmits the terminal location standby direction signal and the reference station assignment signal to the base station (AP4) 1506 that serves as the reference station (Step S188). If the base station (AP3) 1505 and the base station (AP4) 1506 each receive the terminal location standby direction signal from the base station (AP1) 1503, each of them sends back an ACK signal (Steps S187, S189) and shifts to the terminal location standby state (Step S193, S194).

Since the base station (AP4) 1506 and the base station (AP6) 1508 each receive the reference station assignment signal along with the terminal location standby direction signal, each of them shifts to the standby state in location reference station mode of waiting the location signal transmitted from the terminal as the reference station (Step S193).

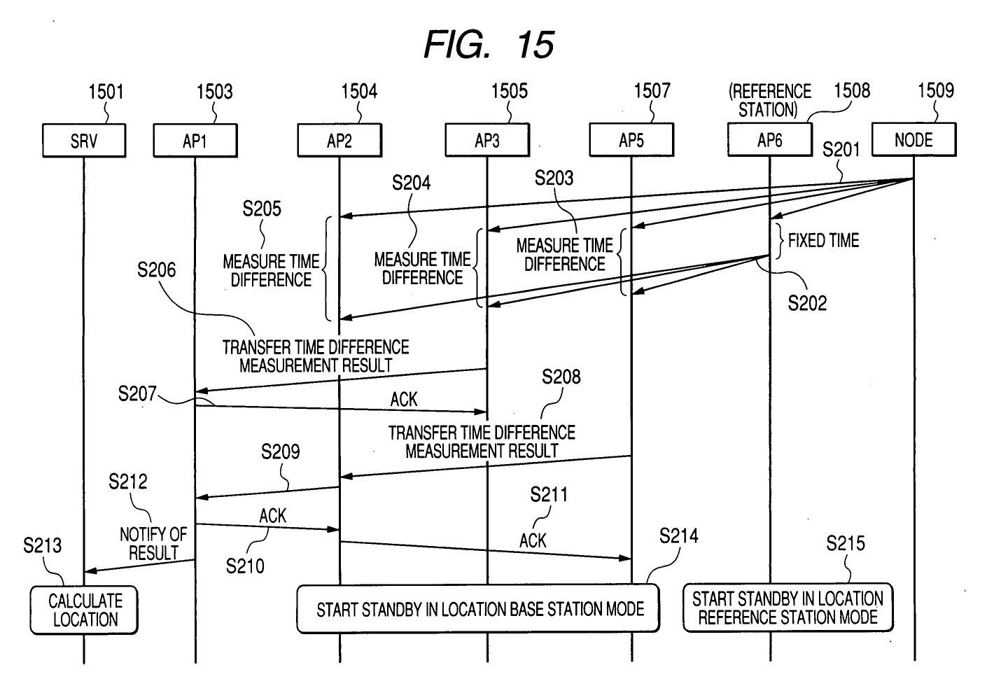

FIG. 15 is a sequence diagram showing a procedure of positioning of the terminal of the third embodiment.

First, the terminal 1509 transmits a location signal to neighboring base stations (Step S201). If the base station (AP6) 1508 that serves as the reference station receives the location signal transmitted from the terminal 1509, the base station (AP6) 1508 transmits the reference signal to neighboring base stations after a lapse of the previously specified time (Step S202).

On the other hand, if the base station (AP2) 1504, the base station (AP3) 1505, and the base station (AP5) 1507 that do not serve as the reference station each receive the location signal transmitted from the terminal, each of them starts operation of the counter 113 and starts to measure a time difference of arrival. Then, if the base station (AP2) 1504, the base station (AP3) 1505, and the base station (AP5) 1507 each receive the reference signal transmitted from the reference station (AP6) 1508, each of them stops operation of the counter that started the operation on reception of the location signal and measures a time difference of arrival between the location signal and the reference signal (Steps S203, S204, and S205).

The base station (AP3) 1505 notifies the base station (AP1) 1503 of the measurement result of the time difference of arrival by wireless communication (Step S206). If the base station (AP1) 1503 receives the measurement result from the base station (AP3) 1505, the base station (AP1) 1503 sends back an ACK signal to the base station that is a sender of the measurement result (Step S207).

The base station (AP5) 1507 notifies the base station (AP2) 1504 of the measurement result of the time difference of arrival by wireless communication (Step S208). The base station (AP2) 1504 transfers the measurement result transmitted from the base station (AP5) 1507 to the base station (AP1) 1503 (Step S209). Simultaneously, the base station (AP2) 1504 transmits the measurement result of a time difference of arrival of the local station to the base station (AP1) 1503 along with the results of the other stations by wireless communication (Step S209).

If the base station (AP1) 1503 receives the measurement result from the base station (AP2) 1504, the base station (AP1) 1503 sends back an ACK signal to the base station (AP2) 1504 that is a sender of the measurement result (Step S210). If the base station (AP2) 1504 receives the ACK signal station from the base station (AP1) 1503, the base station (AP2) 1504 sends back an ACK signal to the base station (AP5) 1507 that is a sender of the measurement result (Step S211).

The base station (AP1) 1503 notifies the location server 1501 of all the measurement results received from the other base stations (Step S212). The location server 1501 calculates the position of the terminal based on the measurement results of the time differences of arrival in the base stations (AP2 to AP5) 1504-1507 and the calculation results of the relative coordinates of the base stations (AP2 to APS) 1504-1507 (Step S213).

After that, the base stations (AP2 to AP6) 1503-1508 each are again set in the standby state in location base station mode. The base station (AP6) 1508 that serves as the reference station is again set in the standby state in location reference station mode.

As described above, according to the third embodiment, also when a new base station is added in order to expand the terminal location area, only a plurality of base stations need to be disposed and the relative coordinates of the base stations can be obtained by wireless communication without accurately measuring disposed positions of the base stations manually; therefore, expansion of the terminal location system can be simplified. Furthermore, since each base station is relayed by radio to communicate with the location server, laying of wire communication lines can be omitted. Moreover, the flexibility in disposing the base station can be improved.

What is claimed:

1. A terminal location system having at least (N+1) base stations, wherein N is in the range of 1 to 3, wherein a terminal location server finds a position of a terminal performing wireless communication in N-dimensional coordinates, and wherein relative coordinates among the at least (N+1) base station are calculated, comprising:
a calculation of relative coordinates among the base stations;
an evaluation of the obtained relative coordinates; and
a switch to terminal location processing for determining the position of the terminal;
wherein the determining of the position of the terminal comprises using propagation times of radio signals transmitted and received between the terminal and the base stations in accordance with the evaluated, obtained relative coordinates of the base stations.

2. The terminal location system according to claim 1,
wherein the at least (N+1) base stations obtain distances among the base stations by measuring propagation times of radio signals among the base stations, and
wherein the relative coordinates of the base stations are measured based on the measured distances among the base stations.

3. The terminal location system according to claim 2,
wherein each of the at least (N+1) base stations measures a first propagation time of the radio signal between itself and the terminal, and measures a second propagation time between itself and at least one other of the base stations, and wherein the position of the terminal is obtained using a difference between the first propagation time and the second propagation time.

4. The terminal location system according to claim 1,
wherein the at least (N+1) base stations include a first base station and at least one second base station, and wherein, if the first base station receives a ranging standby direction from the terminal location server, the first base station transmits a ranging standby direction to the at least one second base station and shifts to a ranging standby state;
and wherein, if the second base station receives the ranging standby direction from the first base station, the second base station shifts to the ranging standby state and transmits an acknowledge signal of being in the ranging standby state;
and wherein, if the first base station receives the acknowledge signals from each of the second base stations having transmitted ranging standby directions, the first base station transmits a signal of completion of the ranging standby states to the terminal location server.

5. The terminal location system according to claim 1,
wherein the radio signals comprise ultra wideband impulse radio signals that send an impulse signal.

6. The terminal location system according to claim 5,
wherein the impulse signal has a pulse width of 3 ns or less.

7. The terminal location system according to claim 1,
wherein the evaluation of the relative coordinates of the base stations comprises outputting an error of the relative coordinates of the base stations, and wherein the calculation of the relative coordinates is obtained by searching a group of the coordinates that minimizes the outputted error.

8. The terminal location system according to claim 7,
wherein the evaluation uses the least squares method.

9. The terminal location system according to claim 7,
wherein the evaluation comprises comparing the obtained error outputted from the evaluating and a previously specified threshold.

10. The terminal location system according to claim 1,
further comprising a display for displaying the obtained relative coordinates among the base stations superimposed on a map of the base stations, and an obtaining of absolute positions of the base stations by altering a spatial relationship of the relative coordinates on the map through image mirroring and rotation.

11. The terminal location system according to claim 1,
wherein the location system selects any one of the at least (N+1) base stations as a reference base station,
and wherein the selected reference base station transmits a reference signal to synchronize the other base stations,
and wherein each of the base stations that does not serve as the reference station measures a first propagation time of a radio signal between itself and the terminal, and measures a second propagation time between itself and the reference base station, and
and wherein the terminal location system obtains the position of the terminal using the first propagation time and the second propagation time.

12. A terminal location system having at least (N+1) base station, wherein N=1 to 3, and a location server, that finds a position of a terminal performing wireless communication in N-dimensional coordinates, the terminal location system comprising:
a relative coordinate detection unit that calculates distances among the at least (N+1) base stations and finds relative coordinates of the base stations;
a determination unit that evaluates the obtained relative coordinates and determines a switching to terminal location processing for finding the position of the terminal; and
a terminal location unit that finds the position of the terminal using propagation times of radio signals transmitted and received among the terminal and the base stations at the obtained relative coordinates of the base stations.

13. The terminal location system according to claim 12,
wherein the at least (N+1) base stations include a first base station connected with the location server by wire and a second base station connected with the first base station by radio signal,
wherein the second base station communicates with the location server by the first base station relaying the radio signal over the wire,
wherein the second base station measures a propagation time of the radio signal between itself and other base stations, and notifies the first base station of the measurement of the propagation time, and
and wherein the first base station notifies the location server by the wire of the measurement of the propagation time transmitted from the second base station.

14. The terminal location system according to claim 12,
wherein at least one of the base stations is connected with the location server by radio signal, and the base station measures a propagation time of a radio signal and notifies the location server of the measurement result of the propagation time by the radio signal.

15. The terminal location system according to claim 12,
wherein the base stations include a first base station connected with the location server by wire, a second base station connected with the first base station by radio, and a third base station connected with the second base station by radio;
wherein the second base station communicates with the location server by relaying through the first base station,
and the third base station communicates with the location server by relaying through the second base station and the first base station;
wherein the third base station measures a propagation time of a radio signal between itself and the other base stations, and notifies the measurement result of the propagation time to the second base station,
and the second base station notifies the first base station of the measurement result of the propagation time transmitted from the third base station, and
the first base station notifies the location server of the measurement result of the propagation time transmitted from the second base station.

16. The terminal location system according to claim 15,
wherein, if the first base station receives a ranging direction from the location server, the first base station transmits a ranging direction to the second base station,
and if the second base station receives the ranging direction from the first base station, the second base station transmits a ranging direction to the third base station,
and if the third base station receives the ranging direction from the second base station, the third base station specifies a fourth base station contained in the received ranging direction, transmits a ranging signal to the specified fourth base station, and shifts to a standby state of an acknowledge signal to the ranging signal, and
if the third base station receives the acknowledge signal from the fourth base station, the third base station measures a propagation time of a radio signal between itself and the fourth base station, and transmits the measured propagation time of the radio signal to the location server via the second base station and the first base station.

17. The terminal location system according to claim 15,
Wherein, if the first base station receives a location standby direction from the location server, the first base station transmits a location standby direction to the second base station,
and if the second base station receives the location standby direction from the first base station, the second base station transmits a location standby direction to the third base station and shifts to a location signal standby state,
and if the third base station receives the location standby direction from the second base station, the third base station shifts to a location signal standby state and transmits an acknowledge signal to the location standby direction, and
if the second base station receives the acknowledge signal from the third base station, the second base station transmits completion of the location standby state to the location server via the second base station and the first base station.

18. The terminal location system according to claim 15,
wherein the second and third base stations each measure a first propagation time of a radio signal between itself and the terminal, measure a second propagation time of a radio signal between itself and the other base station, and the position of the terminal is found using a differencing between the first propagation time and the second propagation time.

19. A positioning method in a terminal location system that has at least (N+1) base stations and a location server, the positioning method comprising the steps of:
calculating distances among the at least (N+1) base stations;
calculating relative coordinates of the base stations;
evaluating the obtained relative coordinates;
determining to switch to terminal location processing for finding a position of a terminal;
measuring a propagation time of a radio signal transmitted and received between the terminal and the base station; and
finding by the location server of the position of the terminal in N-dimensional coordinates using the measured propagation times and the obtained relative coordinates of the base stations.

20. The positioning method in a terminal location system according to claim 19,
wherein the location server transmits a ranging standby direction to the base stations,
and if the base stations each receive the ranging standby direction transmitted from the location server, each base station shifts to a ranging standby state and measures a propagation time of the radio signal among the base stations, and
the location server calculates distances among the base stations based on the propagation times, calculates relative coordinates among the base stations, evaluates the obtained relative coordinates, determines switching to the terminal location processing for finding the position of the terminal, and transmits a location standby direction to the base stations after having done switching to the terminal location processing,
and if the base stations each receive the location standby direction transmitted from the location server, each of them shifts to a location standby state, measures a first propagation time between itself and the terminal, measures a second propagation time between itself and the other base station, and the server calculates the position of the terminal using a differencing between the first propagation time and the second propagation time and the relative coordinates of the base stations.
